(19) United States
(12) Patent Application Publication
(10) Pub. No.: US 2016/0375472 A1
(43) Pub. Date: Dec. 29, 2016

(54) A Supercritical Fluid Extraction System and Method

(71) Applicant: COLEG SIR GÂR, Llanelli, Carmarthenshire (GB)

(72) Inventor: Brian Minty, Carmarthenshire (GB)

(21) Appl. No.: 15/125,125

(22) PCT Filed: Mar. 10, 2015
(86) PCT No.: PCT/GB2015/050685

§ 371 Date: Sep. 9, 2016

(30) Foreign Application Priority Data
Mar. 10, 2014 (GB) 1404200.6

(51) Int. Cl. B09C 1/08; B01D 11/02

(52) U.S. Cl. CPC B09C 1/08; B01D 11/0203; B01D 11/0226; B01D 11/0207

(57) ABSTRACT

A contaminant extraction system has been disclosed for a material containing a soluble contaminant, comprising; an elongate housing and a pressurised treatment chamber located within at least part of the elongate housing. The treatment chamber has a closeable inlet and a closeable outlet, whereby the closeable outlet is spaced apart from the closeable inlet. At least one further inlet is provided for enabling the insertion of a fluid into the treatment chamber. The fluid is sustainable in a solvent state so as to enable extraction of the soluble contaminant. A pressure controller is also provided for maintaining the pressure within the treatment chamber at a predetermined value so as to maintain the fluid in the solvent state.

This invention relates to an extraction system and method of using supercritical fluid, in particular for soil located at a brown field site.

There are many sites in the world where there has been past industrial activity, for example mining or steel works and which have since become derelict. It is generally desired to re-use such previously used derelict sites for residential development to satisfy the housing demand for the ever growing population or for community use in some other way, rather than to build on or utilise green field sites. This requires remediation of the contaminated land on brown field sites which can be expensive to apply, especially on large scales.

Currently there are four main established methods in the marketplace for dealing with contaminated land including encapsulation of the contaminated soil, landfill sites, thermal desorption and purging (where warm air is pumped into the contaminated land, and a vacuum pump placed at the other end of the contaminated soil withdraws the air and any contaminating vapour that has been extracted). The method chosen depends on several factors, including the type of site, the contamination levels, any transport costs, landfill fees and the quantity of material to be processed or stored.

Each of these methods has its drawbacks, for example when using the encapsulation method, whereby the soil is encapsulated in a concrete sarcophagus, the contamination level is not reduced and therefore cannot be used for highly contaminated materials, especially where there will be eventual public access (due to the possibility of leachation which has to be constantly monitored).

Considering the landfill option, there is now a limit on the number of authorised sites to handle contaminated material, and landfill sites are coming under increasing legislative and financial pressure, with strict controls being placed on the composition of the soil that is landfilled, leading to the requirement of pre-treatment.

Finally thermal desorption requires a substantial amount of energy, meaning it is generally reserved for small areas or volume of highly contaminated material, and the costs associated with this method can rise dramatically. Plus for high levels of contamination it is a lengthy process.

A well known alternative method is to use supercritical fluid to remove unwanted contaminants from the media. The supercritical fluid is used as a solvent to enable the penetration and extraction of soluble organic material from solids, liquids, solutions, suspensions or sludges/slurries. It is well known to use Carbon Dioxide (CO₂) for this application because it is cheap, chemically benign, abundant and has a relatively low critical temperature and pressure. It also has the ability to mimic several traditional organic solvents used for cleaning purposes, which have now been discontinued in line with environmental directives and legislation.

The development of a new commercially scalable technology is required to assist industry in complying with the increasing demand of environmental laws for the reclamation, cleanup and re-use of materials.

The use of supercritical fluids as a method of extracting contaminants from soil and associated materials, has been proven on a laboratory scale, and using a batch method.

The batch method requires a fixed quantity of material to be isolated and excavated prior to treatment of the material above ground. The treated soil is then subsequently replaced back into the ground. It is common for the ‘batch of material’ to be transported off-site. This is particularly likely if there are high levels of contamination. Whilst this batch method is advantageous in that it allows accurate control of the working pressure of the liquid carbon dioxide it is generally more desirable to treat the soil in situ because contamination can be dispersed during transportation and transportation costs can be expensive.

The alternative supercritical fluid extraction technique is continuous extraction, which is more efficient and more cost effective than batch mode extraction since it offers the treatment of the material in situ, without the removal of the contaminated media from the site. It is a versatile extraction method whereby it allows treatment of small, as well as large areas of contamination. However, an affordable commercially applicable system has not yet been fully realised. The paper of Fortin et al entitled ‘Fully-continuous supercritical fluid extraction of Naphthalene from soil slurries’ shows that the continuous extraction method works, but that the system described therein is not favourable to be scaled up for commercial use.

Chinese patent application CN1781572, on the other hand, does disclose a continuous supercritical fluid extraction device, but the device comprises expensive components which may be detrimental to the competitiveness of the device compared to those extraction devices currently on the market. The use of filters at the input render the device useless for use with solids and suspended materials, therefore its commercial capability is limited. Further, basic calculations suggest that scaling up the system for commercial activities is not feasible since the size of the resulting extraction device would be unwieldy and not easily transportable to the site to be decontaminated.

The present invention is derived from the realisation that there exists a need to provide a controlled material decontamination process and device suitable for commercial use in-situ at brown field sites, on an industrial scale so as to encourage regeneration and re-use of the materials, whilst ensuring the process and device are affordable and feasible to industry.

According to the invention there is provided a contaminant extraction system for a material containing a soluble contaminant, comprising:
an elongate housing,
a pressurised treatment chamber located within at least part of the elongate housing, the treatment chamber having a closeable inlet, a closeable outlet spaced apart from the closeable inlet and at least one further inlet for enabling the insertion of a fluid into the treatment chamber, the fluid being sustainable in a solvent state so as to enable extraction of the soluble contaminant; and
a pressure controller for maintaining the pressure within the treatment chamber at a predetermined value so as to maintain the fluid in the solvent state.

The contaminated material may be inserted into the closeable inlet when in its open state and expelled from the closeable outlet whilst in its open state whilst isolating the treatment chamber from the outside medium. This is necessary to maintain the pressure within the treatment chamber throughout the decontamination process and enables the continuous feed of contaminated material into the system.

The fluid may be carbon dioxide changeable between a gaseous state and a supercritical fluid state in which it displays the property of a solvent. The supercritical fluid carbon dioxide is then able to extract the contaminant from the material.

There may be included transportation means to move the material through the treatment chamber between the inlet and the outlet. This provides a continuous feed of the material through the system.

The transportation means may be configured to agitate the material to ensure contact of the fluid with the material. This increases the likelihood of the contaminant being removed as the surface area of the material exposed to super fluid carbon dioxide is maximised.

The transportation means may be a screw conveyer.

A controllable valve at the closeable inlet may be included, the valve being moveable between a first closed state for prohibiting passage of material into the treatment chamber and a second open state facilitating movement of material into the treatment chamber. This controls the entry of material within the system.

A controllable valve at the closeable outlet may be included, the valve being moveable between a first closed state for prohibiting passage of the material out of the treatment chamber and a second open state facilitating expulsion of material from the treatment chamber. This controls the ejection of decontaminated material from the system.

A first valve assembly may be positioned at the closeable inlet. The first valve assembly may include a first valve and a second valve spaced apart from the first, valve, with an isolation chamber positioned there-between. This provides a space that is accessed by the material prior to entry into the treatment chamber. It is a pre-holding chamber.

A valve controller may be included for controlling the first valve assembly.

The valve controller may prohibit the first and second valve of the valve assembly from being set to the open state simultaneously. This ensures that the pressure in the treatment chamber is maintained on insertion of material into the system.

In a first configuration both the first and second valves of the first valve assembly may be in a closed state.

In a second configuration the first valve of the valve assembly may be in the open state and the second valve of the valve assembly may be in the closed state. This enables the material to be inserted into the isolation chamber of the system by prohibits access to the main treatment chamber.

In a third configuration the first valve may be closed and the second valve may be opened. The second valve is only opened once the pressure in the isolation chamber is matched to that in the treatment chamber.

Prior to an open state being enabled, both the first valve and the second valve of the valve assembly may be in the closed state. This is a failsafe to ensure that the pressure in the treatment chamber is maintained.

A second valve assembly may be positioned at the output. Similar to the input the decontaminated material must exit the system without having a detrimental effect on the pressure in the treatment chamber.

The second valve assembly may include a first valve and a second valve spaced apart from the first valve, with a post-treatment chamber there-between. This is a space accessible by the material after the treatment has been carried out in the treatment chamber.

A valve controller for controlling the second valve assembly may be included. This ensures that the valves are suitably controlled to maintain the pressure in the treatment chamber.

The valve controller may prohibit the first and second valve of the second valve assembly from being set to the open state simultaneously,

In a first configuration both the first and second valves of the second valve assembly may be in a closed state.

In a second configuration the first valve in the second valve assembly may be in the open state and the second valve in the second valve assembly may be in the closed state.

In a third configuration the first valve in the second valve assembly may be closed and the second valve may be opened.

Prior to an open state being enabled, both the first valve and the second valve of the second valve assembly may be in the closed state.

On closure of the second valve of the second valve assembly, the pressure within the post-treatment chamber may be below the critical pressure of the fluid. The fluid is the supercritical fluid carbon dioxide.

The fluid may return from its supercritical fluid state to its gaseous state causing the deposition of the soluble contaminant within the post-treatment chamber.

The fluid may be recycled in the system.

There may be a continuous supply of contaminated material to the input assembly. This is only enabled because of the input valve assembly.

There may be a continuous supply of fluid to the at least one further input.

There may be included a heater for altering the density of the fluid so as to target specific soluble contaminants.

In a further embodiment of the invention there is provided a method of extracting a soluble contaminant from a contaminated material implementing the above-mentioned system, the method comprising:
inserting a contaminated material into the inlet of the elongate housing;
treating the contaminated material in the treatment chamber;
outputting the resulting decontaminated material via the output, and
maintaining the pressure of the treatment chamber throughout each stage of the method.
The method may further include:
switching the closeable inlet to its open state; inserting contaminated material through the closeable inlet and maintaining the pressure within the treatment chamber.

The material may be placed in an isolation chamber between a first valve and a second valve of an inlet valve assembly prior to entering the treatment chamber.

When the first valve and the second valve of the inlet valve assembly are in the closed state, gas may be expelled from the isolation chamber. This matches the pressure within the isolation chamber to that in the treatment chamber.

The method may further include;
switching the closeable outlet to its open state;
expelling the de-contaminated material through the closeable outlet; and
maintaining the pressure within the treatment chamber.

The material to be treated may be placed in a post treatment chamber between a first valve in a state and a second valve in a state of an outlet valve assembly prior to being expelled from the contaminant extraction system.

Depressurisation may occur in the post-treatments chamber when the first and second valves of the outlet valve are in the closed state. This enables the carbon dioxide to become gaseous and for any decontaminants to be removed therefrom.

Matter may be transported through the length of the treatment chamber via a conveyer.

Whilst the invention has been disclosed above it extends to any inventive combination of the features set out above, or in the following description, drawings or claims.

The invention will now be described, by way of example only, with reference to the accompanying drawing in which:

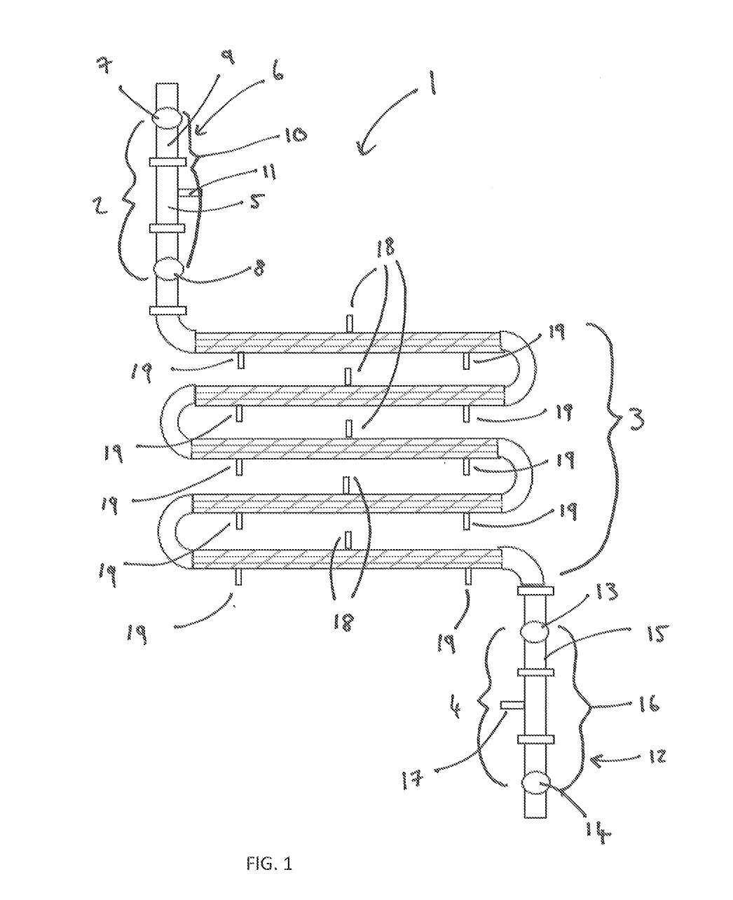

FIG. 1 is a schematic of the contaminant extraction system of the invention.

Referring to FIG. 1, there is shown a decontamination system 1 that applies a Supercritical Fluid (SF) to a material in order to remove unwanted contaminants. This is a well known technique operated at low temperature that leaves no solvent residues.

A SF is a substance, which above its critical temperature and pressure is no longer in the gaseous or liquid phase, but is a fluid. In this supercritical fluid state it has advantages of both gases and liquids whereby its viscosity is more gas like, the diffusivity is more gas like and the density is more characteristic of a liquid. Carbon dioxide (CO₂) is the most commonly used compound as a SF since it is cheap, chemically benign, abundant, non-toxic and has limited environmental impact compared to fluorinated, chlorinated or liquid organic solvents (VOC emissions). CO₂ has the critical parameters of T_{c} (critical temperature)=304 K (31° C.) and P_{c} (critical pressure)=7.38 Mpa (74 bar).

The use of CO₂ is desirable because by controlling the density of supercritical fluid carbon dioxide, achieved by altering its pressure and temperature, it can imitate a range of organic solvents which have traditionally been used to extract organic analytes from a wide variety of matrices. Most of the traditional solvents, however, are ozone depleting and are banned under the Montreal Protocol. As an example, toxic wastes, like PCBs or radioactive waste, can be processed using SF CO₂. The density of the CO₂ can be controlled by heating devices and high pressure pumps thereby allowing it to be used to target a variety of compounds.

The process of decontamination comprises feeding material into the system, applying the SF CO₂ treatment under a predetermined pressurised condition, collecting the contaminant from the CO₂ and expelling the decontaminated material from system. The CO₂ is then reused.

The SF CO₂ is produced from CO₂ gas or liquid from which is pressurised and temperature controlled by a pump, heater and chiller system before the supercritical fluid is introduced into the extraction system.

Carbon dioxide only exhibits the required solvating properties when in this supercritical state or when in the dense gas phase (just before it reaches its supercritical parameters) thereby allowing for the recovery of the extracted contaminant on de-pressurisation so as to revert the CO₂ back to its gaseous state. The carbon dioxide can then be re-cycled for further use, while the solubilised contaminant is deposited, removed and disposed of.

Further, the relatively low, physical properties of the supercritical fluid state of CO₂ allow the use of commercially available pumps and delivery systems with little modification making the phase transition of the CO₂ easy to implement.

The system 1 as shown in FIG. 1, comprises an inlet assembly 2 for inserting the material to be treated into an treatment chamber 3. An outlet assembly 4 is also provided subsequent to the treatment chamber 3 for enabling expulsion of the contaminant. The inlet and outlet assemblies 2, 4 are spaced apart by a length of the pipe 5 and flow of the supercritical fluid is permitted there-between. The operation of the inlet assembly 2 and the outlet assembly 4 are configured to maintain the pressure in the treatment chamber 3 so as to provide the desired extracting effect of the SF CO₂. The desired pressure of the carbon dioxide is provided by a 00₂ pressurisation device (e.g. a pump suitable for liquid CO₂ handling) (not shown) and the pressure is monitored and regulated by a pressure regulation device (not shown),

The inlet assembly 2 is provided at a first end 6 of the treatment chamber 3, having a first and second valve 7, 8 spaced apart by a length of pipe or tube 9. The first and second valve 6, 7 at the inlet 2 of the system 1 form a first valve assembly or inlet assembly 2. The region between the first and second valve is an isolation chamber 10 enabling the treatment chamber 3 to be separated from the outside world on insertion of the material. The first valve 7 is an outer valve positioned between the isolation chamber 10 and the outside world, whereas the second valve 8 is an inner valve positioned between the isolation chamber 10 and the treatment chamber 3. An exhaust pipe 11 extends from a side of the isolation chamber 10. This enables air to be expelled from the isolation chamber 10.

In the default state of the inlet assembly 2 and on initiation of the decontamination process of a material, both the first and second valves 7, 8 of the inlet assembly 2 are closed in a first configuration. In a second configuration the first valve 7 of the inlet assembly 2 is opened and the second valve 8 remains closed to enable material to enter the isolation chamber 10. The first valve 7 of the inlet assembly 2 is then closed to return the inlet valve assembly 2 to the first configuration so as to isolate the material in the isolation chamber 10 between the first and second valves 7, 8. The isolation chamber 10 may then be evacuated of gas by means of the exhaust pipe 11 and pump assembly (not shown). Subsequently, a third configuration is provided whereby the second valve 8 of the inlet assembly 2 is opened, with the first valve 7 of the inlet assembly 2 remaining closed, so as to permit the transfer of the material from the isolation chamber 10 to the treatment chamber 3. The second valve 8 of the inlet assembly 2 is subsequently closed to return the inlet assembly 2 to the first, default configuration.

At no point are the first and second valves 7, 8 of the inlet assembly 2 opened at the same time, otherwise this would be detrimental to the maintenance of the pressure which is to be maintained within the treatment chamber 3. This is important since the pressure is a variable in determining the property of the CO₂.

At the second end of the treatment chamber is provided the outlet assembly 4, comprising a first and second valve 13, 14 spaced apart by a tube or pipe 15. The first and second valve 13, 14 at the outlet form a second valve assembly or outlet assembly 4. A post treatment chamber 16 is provided between the first (internal) and second (external) valve 13, 14 of the outlet assembly 4. In the default state and on completion of the treatment of a batch of material, both the first and second valves 13, 14 of the outlet assembly 4 are closed in a first configuration. In a second configuration the first valve 13 of the outlet assembly 4 is opened and the second valve 14 of the outlet assembly 4 is closed to enable material to enter the post treatment chamber 16 from the treatment chamber 3. The first valve 13 is then closed to return the outlet assembly 4 to the first configuration so as to isolate the material in the post treatment chamber 16 between the first and second valves 13, 14 of the outlet assembly 4. The post treatment chamber 16 may then be depressurised by means of an exhaust pipe 17 and pump assembly (not shown) causing the CO₂ to return to its gaseous state and the target compounds to be deposited. The CO₂ gas is then fed back to a pre-superfluid stage for further use in the system i.e. the CO₂ is recycled. Subsequently, a third configuration is provided whereby the second valve 14 of the outlet assembly 4 is opened, with the first valve 13 of the outlet assembly 4 remaining closed, so as to permit the transfer of the decontaminated material from the post treatment chamber 16 into the outside world, thereby returning it to the site from which it was extracted. The second valve 14 of the outlet assembly 4 is subsequently closed to return the outlet assembly 4 to the first, default configuration.

The treatment chamber 3 extends between the inlet assembly 2 and the outlet assembly 4 and comprises a pipe work 5 of approximately 30 cm in diameter. The pipework 5 houses mechanical transportation apparatus (not shown), for example a conveyer, which facilitates the transfer of the material from the inlet assembly 2 to the outlet assembly 3 so as to ensure it passes through the pressurised extraction section that is the treatment chamber 3. An Archimedean screw mechanism is a particularly useful mechanical transportation apparatus for semi-solid materials. The mechanical handling of such a mechanism also ensures that the material is sufficiently agitated so as to ensure optimal contact of the supercritical fluid with the material to be treated. Ultimately, the mechanical handling apparatus further ensures that there is a continuous feed of the material through the system 1. Inlet pipes 18 are provided along the lower sides of the treatment chamber 3 at regular intervals along the length of the pipe 5 and outlet pipes 19 are similarly arranged along the top sides of the treatment chamber 3 at regular intervals along its length. The inlet pipes 18 permit the insertion of SF CO₂ into the treatment chamber and the outlet pipes 19 permit removal of any waste SF CO₂.

The extraction system 2 is applied in an on-site location, where the extraction will take place. The treatment chamber 3 can be extended linearly or alternatively it may be configured in a winding arrangement so as to maximise the length of the treatment chamber 3 for a given area.

In use, the material to be decontaminated is passed into the extraction system 1 through inlet assembly 2. The material is then moved along the treatment chamber 3 until it reaches the outlet assembly 4, which ultimately functions using the reverse operation to that of the inlet assembly 2. Therefore, contaminated material is continually fed into, and passed through the extraction system 1, with decontaminated material being continually removed from the system, all whilst maintaining the required pressure and temperature for the treatment.

The arrangement of the valves of the inlet and outlet assemblies are key to maintaining the pressure of the treatment chamber 3. The default position is when the first valve 7 of the inlet and the second valve 8 of the inlet are closed. Next the first valve 7 of the inlet is opened as the first valve 13 of the outlet is opened. Both the first valve 7 of the inlet and the first valve 13 of the outlet are then closed. Air is then evacuated from the isolation chamber 3 and contaminated SF CO2 is then exhausted from the post treatment chamber 16. Finally, the second valve 8 of the inlet and the second valve 14 of the outlet are opened so as to permit insertion of contaminated material and expulsion of de-contaminated material respectively.

Various modifications to the principles described above would suggest themselves to the skilled person. For example, whilst it has been described to use CO₂, other solvents are applicable. Rather than applying the heating prior to the insertion of the CO₂ in the system, it can be arranged to encompass the system to enable the heating to be carried out while the CO₂ is in the treatment chamber with the material.

The length and the diameter of the associated pipe work 5 can be altered from 30 cm to suit the contamination levels, the quantity of material, the required rate of extraction and the required threshold level of a specific contaminant. For example higher contamination levels can be accommodated by increasing the length of the tubing so as to increase the contact period between the material and the supercritical fluid and therefore increase the extraction time. This is also applicable to achieve reduced threshold levels if required,

Whilst the use of a smaller diameter tube of the extraction vessel reduces the wall thickness and therefore the cost of the device, making it comparably cheaper to the batch mode process, an increased volume of material can be achieved by increasing the diameter of the tubing, so as to increase the throughput of the system. The amount of supercritical fluid can also be altered to optimise the decontamination process.

Whilst it has been described that the angle of the pipe is horizontal, the system is capable of working at various angles ranging from the vertical to the horizontal, depending on the type of material to be extracted. This is required to compensate for the viscosity characteristics of the material.

Although the method of continuous extraction is more complex compared to the batch method, it speeds up the extraction process since it eliminates the requirement to stop the system for the filling and emptying of the extraction vessel.

This process therefore removes the need for excavation and removal techniques which can lead to contamination from transportation and ensures that the decontaminated material is immediately re-usable on site.

It is a system that is applicable for both high and low levels of contamination without the need for major changes to its configuration. Consequently, it is a highly flexible and environmentally friendly system capable of being used for a wide variety of media and site characteristics at an affordable cost compared to current commercial methods for remediation of contaminated land. Ultimately this is a system for extracting contaminants on an industrial scale by continuous mode supercritical CO₂ extraction.

Alternatively to using the inlet and outlet assemblies 2, 3 there may instead be used a closeable inlet valve and a closeable outlet valve (not shown).

What is claimed is:

1. A contaminant extraction system for a material containing a soluble contaminant, comprising:
an elongate housing,
a pressurised treatment chamber located within at least part of the elongate housing, the treatment chamber having a closeable inlet, a closeable outlet spaced apart from the closeable inlet and at least one further inlet for enabling the insertion of a fluid into the treatment chamber, the fluid being sustainable in a solvent state so as to enable extraction of the soluble contaminant; and
a pressure controller for maintaining the pressure within the treatment chamber at a predetermined value so as to maintain the fluid in the solvent state.

2. A contaminant extraction system according to claim 1, wherein contaminated material is inserted into the closeable inlet when in its open state and expelled from the closeable outlet whilst in its open state whilst isolating the treatment chamber from the outside medium.

3. A contaminant extraction system according to claim 1, wherein the fluid is carbon dioxide changeable between a gaseous state and a supercritical fluid state in which it displays the property of a solvent.

4. A contaminant extraction system according to claim 1, wherein there is included transportation means to move the material through the treatment chamber between the inlet and the outlet.

5. A contaminant extraction system according to claim 4, wherein the transportation means is configured to agitate the material to ensure contact of the fluid with the material.

6. A contaminant extraction system according to claim 4, wherein the transportation means is a screw conveyer.

7. A contaminant extraction system according to claim 1, including a controllable valve at the closeable inlet, the valve being moveable between a first closed state for prohibiting passage of material into the treatment chamber and a second open state facilitating movement of material into the treatment chamber.

8. A contaminant extraction system according to claim 1, including a controllable valve at the closeable outlet, the valve being moveable between a first closed state for prohibiting passage of the material out of the treatment chamber and a second open state facilitating expulsion of material from the treatment chamber.

9. A contaminant extraction system according to claim 1, wherein positioned at the closeable inlet is a first valve assembly.

10. A contaminant extraction system according to claim 9, wherein the first valve assembly includes a first valve and a second valve spaced apart from the first valve, with an isolation chamber positioned there-between.

11. A contaminant extraction system according to claim 10, wherein there is further included a valve controller for controlling the first valve assembly.

12.-16. (cancelled)

17. A contaminant extraction system according to claim 1, wherein positioned at the output is a second valve assembly.

18. A contaminant extraction system according to claim 12, wherein the second valve assembly includes a first valve and a second valve spaced apart from the first valve, with a post-treatment chamber there-between.

19. A contaminant extraction system according to claim 13, wherein there is included a valve controller for controlling the second valve assembly.

20.-27. (canceled)

28. A contaminant extraction system according to claim 1, where there is a continuous supply of contaminated material to the input assembly.

29. A contaminant extraction system according to claim 1, wherein there is a continuous supply of fluid to the at least one further input.

30. A contaminant extraction system according to claim 1, wherein there is included a heater for altering the density of the fluid so as to target specific soluble contaminants.

31. A method of extracting a soluble contaminant from a contaminated material implementing the system of claim 1, the method comprising:
inserting a contaminated material into the inlet of the elongate housing;
treating the contaminated material in the treatment chamber;
outputting the resulting decontaminated material via the output, and maintaining the pressure of the treatment chamber throughout each stage of method.

32. A method according to claim 18, further including:
switching the closeable inlet to its open state;
inserting contaminated material through the closeable inlet and
maintaining the pressure within the treatment chamber.

33. A method according to claim 18, wherein the material is placed in an isolation chamber between a first valve and a second valve of an inlet valve assembly prior to entering the treatment chamber.

34.-40. (canceled)
